(19) United States
(12) Patent Application Publication
(10) Pub. No.: US 2002/0009318 A1
(43) Pub. Date: Jan. 24, 2002

(54) Braille printer and braille printing method

(76) Inventor: Toshiyuki Maie, Tokyo (JP)

Correspondence Address: McGLEW AND TUTTLE, P.C., SCARBOROUGH STATION, SCARBOROUGH, NY, 10510-0827, US

(21) Appl. No.: 09/907,244

(22) Filed: Jul. 17, 2001

(30) Foreign Application Priority Data
Jul. 21, 2000 (JP) JP 2000-220161

(51) Int. Cl. B41J 3/32

(52) U.S. Cl. 400/109.1

(57) ABSTRACT

A Braille printer comprises a frame on which a gauze is stretched, and a sheet which is adhered to the gauze and in which a Braille pattern is formed, wherein Brailles are printed by coating printing ink onto the sheet.

### BACKGROUND OF THE INVENTION

1. Field of the Invention

The present invention relates to a Braille printer and a Braille printing method and, more particularly to a Braille printer and a Braille printing method employing a Braille printing plate formed by a very simple approach.

2. Description of the Related Art

When the Braille is printed, such Braille having a some height must be printed to permit the reader to read the Braille clearly.

For this reason, the Braille printing plate is prepared by the approach shown in FIGS. 5A to 5G in the prior art.

First, as shown in FIG. 5A, a thick film 13 in which a base film 11 and a cover film 12 are adhered to both sides of a sensitizer 10 to hold it is prepared, then such film 13 is placed on a flat working table made of cellular styrol, for example, and then the base film 11 is removed.

Then, as shown in FIG. 5B, the silk screen printing frame 15, on a lower surface of which a gauze 16 is stretched, is loaded on the surface of the sensitizer 10 from which the base film 11 is removed, and then the sensitizer 10 is adhered to the gauze 16.

Then, as shown in FIG. 5C, a back-coating emulsion 18 is coated on the gauze 16 by a bucket 17.

Then, as shown in FIG. 5D, the coated back-coating emulsion 18 is dried by the warm air. Such coating/drying of the back-coating emulsion 18 is repeated several times, e.g., four to five times.

Then, as shown in FIG. 5E, the cover film 12 is peeled off.

Then, as shown in FIG. 5F, the mask 19 in which Braille patterns are formed is brought into tight contact with a surface of the sensitizer 10 from which the cover film 12 is removed. Then, the sensitizer 10 is ultraviolet-exposed by an exposure lamp 20 via the mask 19. Accordingly, the sensitizer 10 and the back-coating emulsion 18 located in areas that are covered with transparent portions 19-1 of the mask 19 are exposed, whereas the sensitizer 10 and the back-coating emulsion 18 located in areas that are covered with opaque portions 19-2 of the mask 19 are not exposed.

Then, as shown in FIG. 5G, when the sensitizer 10 side and the back-coating emulsion 18 side of the frame 15 are rinsed in water by the soft brush, the exposed portions remain but the unexposed portions are rinsed off. As a result, the Braille printing plate consisting of the exposed sensitizer 10 and the back-coating emulsion 18, both sandwich the gauze 16 of the frame 15 between them, can be obtained.

If the Braille is printed in ultraviolet curing resin ink while using this printing plate, it is possible to print the Braille having the large thickness.

Meanwhile, as shown in FIGS. 5A to 5G, since a large number of complicated steps are required for the Braille printing in the prior art, the plate making cost is extremely increased and accordingly the resultant printed matter becomes expensive.

### SUMMARY OF THE INVENTION

It is an object of the present invention to provide a Braille printer capable of improving such problems and also printing Brailles having a large thickness at a low printing cost.

It is another object of the present invention to provide a Braille printing method capable of improving the above problems and also printing Brailles having the large thickness at the low printing cost.

In order to achieve the above object, a Braille printer of the present invention comprises a frame on which a gauze is stretched, and a sheet which is adhered to the gauze and in which a Braille pattern is formed, wherein Brailles are printed by coating printing ink onto the sheet.

Also, a Braille printer of the present invention comprises a frame on which a gauze is stretched, a first sheet which is adhered to the gauze and in which a first Braille pattern is formed, and a second sheet in which a second Braille pattern is formed and which is adhered to the gauze on a side opposite to the first sheet to overlap with each other such that the first Braille pattern coincides with the second Braille pattern, wherein the Brailles are printed by coating printing ink onto the first sheet and the second sheet.

In addition, a Braille printing method of the present invention comprises the steps of forming a Braille pattern in a sheet on one surface of which an adhesives is coated by a dot forming machine, adhering the sheet in which the Braille pattern is formed to a gauze portion that is stretched on a silk printing screen frame, and printing Brailles in light curing resin ink.

According to the Braille printer of the present invention, since the plate is prepared by adhering the sheet in which the Braille pattern is formed to the gauze, the plate making cost can become very inexpensive. In addition, since different Braille printings can be carried out by merely replacing the sheet in which the dots are formed, the Braille printed matter having the large number of pages can be printed simply at the low cost.

Also, according to the Braille printer of the present invention, since the sheets in which the same Braille pattern is formed respectively are adhered from both sides of the gauze to overlap with each other, the durability of the plate can be improved much more.

In addition, according to the present invention, in the Braille printing method, since the Braille pattern is formed by the dot forming machine, the size of the dot can be adjusted by controlling the dot forming machine. Thus, when the beginner learns the Braille for the first time, the Braille can be printed in the easy-looking state by slightly expanding the size of the dot. Therefore, the Braille that is convenient for the beginner can be provided.

### BRIEF DESCRIPTION OF THE DRAWINGS

FIGS. 1A to 1C are views showing an embodiment of the present invention;

FIGS. 2A and 2B are views showing a cut-letter sheet;

FIG. 3 is a flowchart showing plate making steps of the present invention;

FIG. 4 is a view showing the sheet reinforcing state; and

FIGS. 5A to 5G are views showing the example in the prior art.

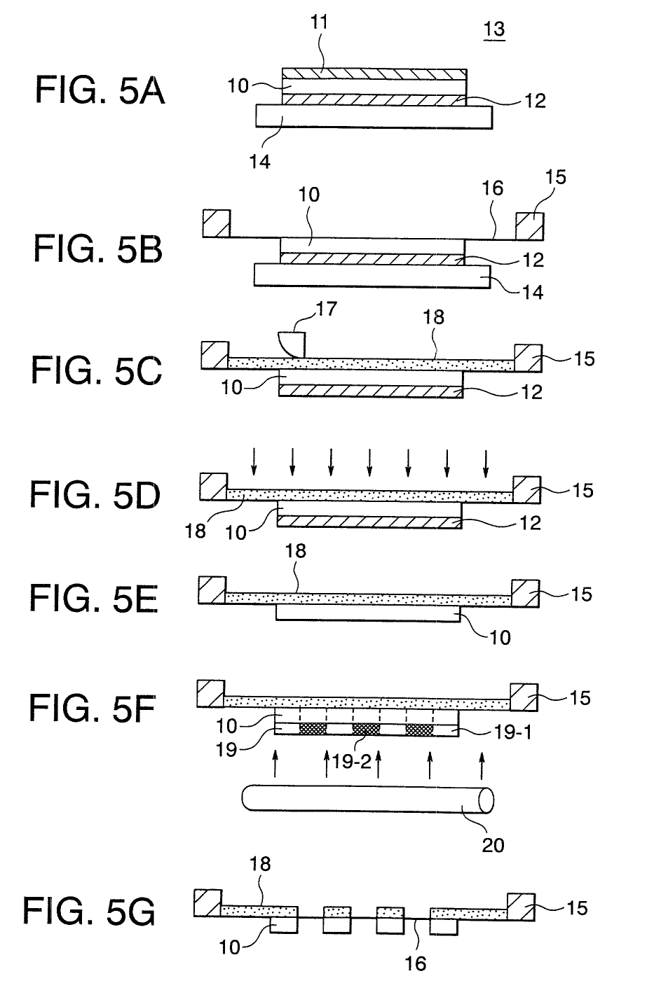

### DESCRIPTION OF THE PREFERRED EMBODIMENT

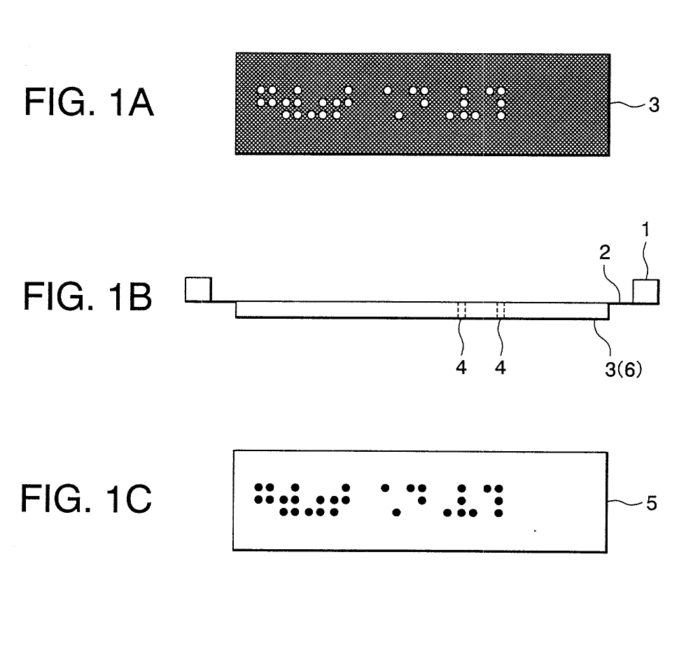

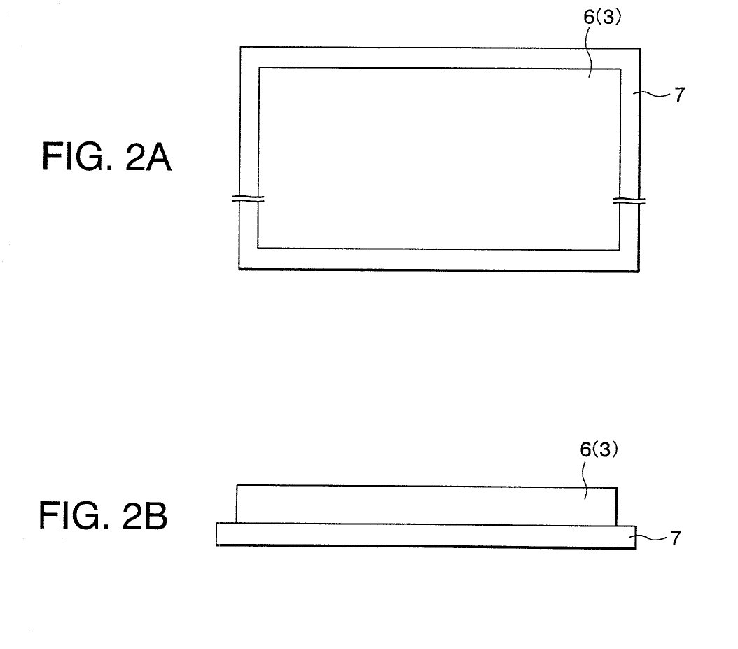

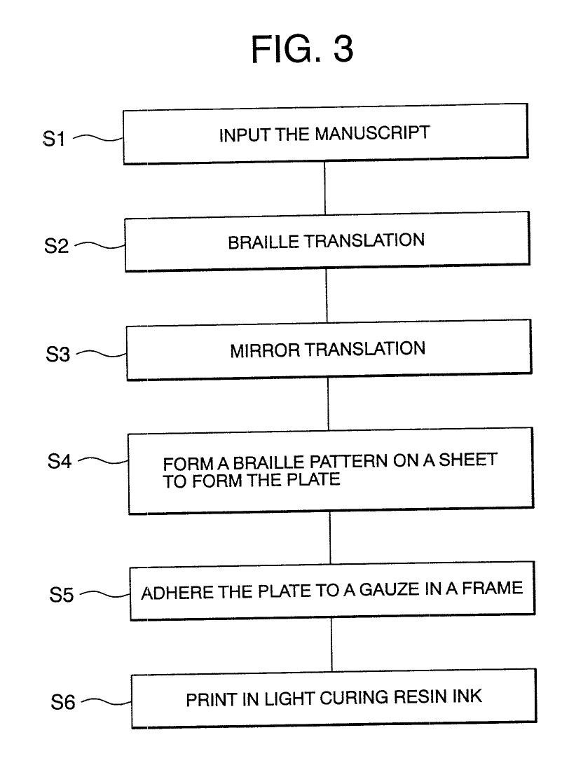

An embodiment of the present invention will be explained with reference to FIGS. 1A to 1C, FIGS. 2A and 2B, and FIG. 3 hereinafter. FIGS. 1A to 1C shows an embodiment of the present invention, FIGS. 2A and 2B are views showing a cut-letter sheet, and FIG. 3 is a flowchart showing plate making steps of the present invention.

In FIG. 1A to FIG. 3, 1 denotes a frame; 2, gauze; 3, plate; 4, Braille pattern; 5, Braille printed matter; 6, sheet; and 7, ground board.

The frame 1 is a screen frame for silk printing. The gauze 2 formed of Tetron (polyethylene terephthalate), polyamide, stainless sheet, or the like, for example, is stretched on a lower surface of the frame 1.

Then, the plate 3 in which the Braille pattern 4, described later, is formed is adhered to the gauze 2.

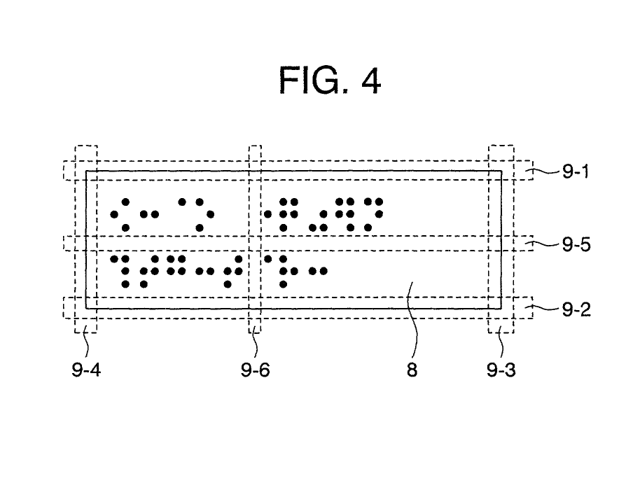

As described later, the plate 3 is prepared by forming the Braille pattern 4 in the sheet 6 shown in FIG. 2A. In this embodiment, the Braille patterns 4 shown in FIGS. 1 and 4 are patterns of Japanese Braille. However, the present invention can be applied to not only Japanese Braille, but Braille of every language such as English, French, Germany, etc. which use the alphabet, and Chinese, Korean, etc. Further, the present invention can be applied to Braille which is not unified on single language or has so many varieties such as English Braille which includes the Standard English Braille, the Computer Braille (e.g. NABCC; North American Braille Computer Code), etc.

The Braille printed matter 5 is a printed matter on which the letters, etc. have been previously printed (by normal ink) and the Brailles (Braille characters or Braille letters) are printed by the light curing resin ink, which is transparent, on the previous printed matter or the letters.

The sheet 6 is a sheet that is formed of vinyl chloride, polyester, etc. to have a thickness of 0.1 mm, for example. The cut-letter sheet called the cutting sheet from which the letters, etc. are cut out and which is pasted onto the signboard or the windowpane, for example, is employed as the sheet 6. The sheet 6 is not limited to these materials. For example, a stainless sheet, an aluminum sheet, or the like may be employed as the sheet 6. Also, the thickness is not limited to the thickness of 0.1 mm. Various thicknesses such as 0.4 mm, 0.5 mm, etc. may be employed.

One surface of the sheet 6 is formed as an adhesive surface on which the adhesives is coated. The sheet 6 is adhered to the ground board 7 via this adhesive surface, as shown in FIGS. 2A and 2B.

In this adhered stated, dots are opened at positions of the Braille pattern 4 from the sheet 6 side by using the dot forming machine available on the market, e.g., the vinyl sheet cutting machine. A depth of the dot can be controlled by adjusting the vinyl sheet cutting machine. For example, when the depth is set to 0.3 mm, the dot having a depth of 0.3 mm is opened. If the sheet 6 has the thickness of 0.4 mm, the depth of the dot may be adjusted to 0.4 mm. In this manner, the depth of the dots to be opened can be adjusted appropriately in response to the thickness of the sheet 6.

Also, if the stainless sheet or the aluminum sheet is employed as the sheet 6, the Braille pattern can be formed by the stainless or aluminum sheet laser machine that is the dot forming machine also available on the market. Since the laser machine can adjust appropriately the depth of the dot, the dots may be opened in the 0.3 mm thick sheet, the 0.4 mm thick sheet, the 0.5 mm thick sheet, or other sheets having any thickness. Of course, the dots may be opened in these sheets by the etching equipment.

Next, plate making steps of the present invention in the case of Japanese Braille will be explained with reference to FIG. 3 hereunder.

Step S1: First, the Japanese (or other language's) manuscript is input in kana into the personal computer. The operator can check whether or not the manuscript has been input properly, by monitoring the display or checking the printout of the input data. Then, if the miss is found, the operator corrects the input manuscript.

Step S2: Then, when the manuscript is input properly in this manner, the operator translates this kana input into the Braille by operating the available Braille translation (or conversion) software.

Step S3: Then, the operator operates the available mirror software to translate the data, that are translated into the Braille, into the mirror Braille pattern, that is obtained by inverting right and left sides mutually as if the Braille is seen in the mirror. This mirror Braille pattern is temporarily saved in the floppy disk, for example.

Step S4: Then, if the mirror Braille pattern saved temporarily in the floppy disk is opened in the vinyl chloride sheet 6, the operator inputs such mirror Braille pattern into the available vinyl sheet cutting machine. Accordingly, the mirror Braille pattern is formed on the sheet 6 from the non-adhesive surface side, and thus the plate 3 shown in FIG. 1 is formed. In this case, the plate 3 shown in FIG. 1A is in the laterally non-inverted state viewed from the gauze 2 side after such plate 3 is adhered to the gauze 2.

Step S5: Then, the adhesive surface of the sheet 6 in which the mirror Braille pattern is opened in above step S4 is peeled off from the ground board 7, and then this adhesive surface of the sheet 6 is adhered to the gauze 2 of the frame 1. Therefore, the plate 3 constructed by the sheet 6 in which the Braille pattern is formed is adhered to the gauze 2 of the silk printing frame 1.

Step S6: Then, by using this frame 1 to which the plate 3 shown in FIG. 1B is adhered, light curing resin ink such as the ultraviolet curing resin ink, for example, is put on an inner area of the frame 1. Then, the Braille printing is carried out by rubbing the light curing resin ink by virtue of the squeegee.

Since the light curing resin ink is transparent, the Braille can be printed on the previous printed matter, etc. on which the letters, etc. have been previously printed to complete the Braille printed matter 5. Thus, this also makes the person., who cannot read the Braille, possible to read the contents of the Braille.

By the way, as shown in FIG. 1, if the sheet 6 in which the Braille pattern 4 is formed is adhered/stuck to the gauze 2, the sticking strength between them is not so strong. Thus, there is the possibility that, if the printing is repeated by a large number of times, the positional displacement is caused. In order to prevent this, as shown in FIG. 4, if a sheet 8 in which the dots are opened is adhered to the gauze 2 (not shown) and then adhesive tapes 9-1, 9-2, 9-3, 9-4 such as a silver tape (thin adhesive tape made of aluminum) for example, are pasted onto four side surfaces of the sheet 8, so as that the adhesive passes through the gauze 2, this adhesive strength can be reinforced. If other adhesive tapes 9-5, 9-6 are pasted onto not only four side surfaces but also areas between the Braille pattern 4, the adhesive strength can be further reinforced. It is a matter of course that only two side surfaces can be reinforced by the adhesive tapes 9-1, 9-2, the adhesive tapes 9-3, 9-4, or the like, for example. In this manner, the sticking strength of the sheet 8 to the gauze 2 can be enhanced by the adhesive tapes 9.

As another embodiment of the present invention, the plate that is constructed by adhering the plate 3 to the gauze 2, as shown in FIG. 1B, and then adhering the sheet having the same Braille pattern as this plate 3 to overlap with the plate 3 may be employed. That is, the plate in this case comprises a first and second sheets. The first sheet (the above plate 3) is adhered to the gauze 2, and a first Braille pattern is formed thereon. The second sheet is formed with a second Braille pattern, and is adhered to the gauze 2 on a side opposite to the first sheet to overlap with each other such that the first Braille pattern coincides with the second Braille pattern. At this time, since the sheet (the above second sheet) in which the Braille pattern is formed, as shown in step S4 in FIG. 3, by using the data, that are translated into the Braille in step S2, not to execute the mirror translation is employed as the overlapping sheet, the same Braille pattern as the plate 3 can be obtained even if two sheets are pasted to overlap with each other.

The plate having the excellent durability can be obtained by overlapping the sheets in this manner.

According to the present invention, in the Braille printer, since the plate is prepared by adhering the sheet in which the Braille pattern is formed to the gauze, the plate making cost can become very inexpensive. In addition, since different Braille printings can be carried out by merely replacing the sheet in which the dots are formed, the Braille printed matter having the large number of pages can be printed simply at the low cost.

Also, according to the present invention, in the Braille printer, since the sheets in which the same Braille pattern is formed respectively are adhered from both sides of the gauze to overlap with each other, the durability of the plate can be improved much more.

In addition, according to the present invention, in the Braille printing method, since the Braille pattern is formed by the dot forming machine, the size of the dot can be adjusted by controlling the dot forming machine. Thus, when the beginner learns the Braille for the first time, the Braille can be printed in the easy-looking state by slightly expanding the size of the dot. Therefore, the Braille that is convenient for the beginner can be provided.

What is claimed is:

1. A Braille printer comprising:
a frame on which a gauze is stretched; and
a sheet which is adhered to the gauze and in which a Braille pattern is formed;
wherein Brailles are printed by coating printing ink onto the sheet.

2. A Braille printer according to claim 1, wherein the printing ink is light curing resin ink which is transparent.

3. A Braille printer according to claim 1, wherein the Brailles are printed on a printed matter on which the letters have been previously printed.

4. A Braille printer according to claim 1, wherein the sheet has at least a adhesive tape pasted on the gauze which is adhered the sheet.

5. A Braille printer comprising:
a frame on which a gauze is stretched;
a first sheet which is adhered to the gauze and in which a first Braille pattern is formed; and
a second sheet in which a second Braille pattern is formed and which is adhered to the gauze on a side opposite to the first sheet to overlap with each other such that the first Braille pattern coincides with the second Braille pattern;
wherein Brailles are printed by coating printing ink onto the first sheet and the second sheet.

6. A Braille printer according to claim 5, wherein the printing ink is light curing resin ink which is transparent.

7. A Braille printer according to claim 5, wherein the Brailles are printed on a printed matter on which the letters have been previously printed.

8. A Braille printer according to claim 5, wherein the sheet has at least a adhesive tape pasted on the gauze which is adhered the sheet.

9. A Braille printing method comprising:
forming a Braille pattern in a sheet, on one surface of which an adhesives is coated, by a dot forming machine;
adhering the sheet, in which the Braille pattern is formed, to a gauze portion that is stretched on a silk printing screen frame; and
printing Brailles in light curing resin ink.

10. A Braille printing method according to claim 9,
wherein the sheet has an adhesive surface which is adhered to a ground board; and
wherein the sheet being formed with the Braille pattern is peeled off the ground board and is adhered to the gauze portion of the silk printing screen frame.
